(19) United States
(12) Patent Application Publication
(10) Pub. No.: US 2010/0206419 A2
(43) Pub. Date: Aug. 19, 2010

(54) STRETCHABLE METAL TUBE

(75) Inventors: MATTHIAS WEISS, 57271 Hilchenbach (DE); KARL-HEINZ MÜNKER, 57271 Hilchenbach (DE); DIETMAR BAUMHOFF, 57462 Olpe (DE); STEFAN HAUK, 57271 Hilchenbach (DE)

Correspondence Address: Henry M. Feiereisen, 708 Third Avenue, Suite 1501, New York, NY, 10017, US, 212-244-5500, 212-244-2233, info@feiereisenllc.com

(73) Assignee: Westfalia Metallschlauchtechnik GmbH & Co. KG, 57271 Hilchenbach (DE)

(21) Appl. No.: 12/062,933

(22) Filed: Apr. 4, 2008

(30) Foreign Application Priority Data
Apr. 5, 2007 (DE) 10 2007 016 784.0

(51) Int. Cl. F16L 11/16

(52) U.S. Cl. 138/135; 138/122

(57) ABSTRACT

A tube is made of profiled metal strip which includes an end leg extending in parallel relationship to a tube axis, an inner leg extending in parallel relationship to the tube axis at a first distance, and an outer leg extending in parallel relationship to the tube axis at a second distance which is greater than the first distance. The inner leg is connected with the outer leg by a transition A double-folded loop hook extends radially for connecting the end leg with one member from the group consisting of the inner leg and the outer leg, and an end hook extends radially and is connected to the other member of this group.

### CROSS-REFERENCES TO RELATED APPLICATIONS

This application claims the priority of German Patent Application, Serial No. 10 2007 016 784.0, filed Apr. 5, 2007, pursuant to 35 U.S.C. 119(a)-(d), the content of which is incorporated herein by reference in its entirety as if fully set forth herein.

### BACKGROUND OF THE INVENTION

The present invention relates to a multi-layer tube formed of metallic profiled strip.

Nothing in the following discussion of the state of the art is to be construed as an admission of prior art.

Metal tubes of a type involved here are described in European patent document EP 0 436 772 A2, U.S. Pat. No. 1,009,964 and German Pat. No. DE 101 13 182 C2 and used as “liner” for conveying gases in decoupling elements of exhaust systems. The tube is typically made of a strip which has an S-shaped profile in an axial inner zone, with both axial outer sides being joined by axial end legs.

Conventional metal tubes normally have loose turns and thus exhibit little directional stability. As a result, the generate noise, such as rattling, when used, as the individual turns strike each other or impact the surrounding metal bellows. In particular critical is here the frequency range of about 200 Hz which excites second-order engine moments in a four-cylinder engine. Another critical frequency range is between 400 Hz and 500 Hz. To address the problem of rattling noises, a wire braid or the like may be pulled over the metal tube like a sock before being fitted within the metal bellows. Moreover, metal tubes are almost exclusively made for interlocking in view of their lower tendency to generate noise, compared to a singly interlocked profile.

Interlocked profiles may be made of metal strips of various width and thickness. Common to all interlock profiles is their limitation of their achievable stretch to a maximum of 42% as a consequence of geometric facts. A greater stretch can only be attained when the interlocking connections no longer sufficiently overlap in compressed state. As a result, the stretching capability, however, gets lost in the absence of a sufficient overlap, so that this option is unacceptable, when decoupling elements are used. A stretch limitation to 42% also adversely affects a dimensioning of a decoupling element comprised of metal tube and bellows. In particular when passenger cars are involved, the maximal attainable lateral offset of the entire element represents the most important criteria as far as dimensioning of such elements is concerned. The stretch of the metal tube is hereby the limiting factor for the possible lateral offset and cannot fall below a certain minimum length of the entire decoupling element. When passenger cars are involved, this minimum length is typically at about 200 mm total length and about 180 mm effective length.

It would be desirable and advantageous to provide an improved tube to obviate prior art shortcomings.

### SUMMARY OF THE INVENTION

According to one aspect of the present invention, a tube is made of profiled metal strip which includes an end leg extending in parallel relationship to a tube axis, an inner leg extending in parallel relationship to the tube axis at a first distance, an outer leg extending in parallel relationship to the tube axis at a second distance which is greater than the first distance, a transition for connecting the inner leg with the outer leg, a double-folded loop hook extending radially for connecting the end leg with one member selected from the group consisting of the inner leg and the outer leg, and an end hook extending radially and connected to the other member of the group consisting of the inner leg and the outer leg.

The end leg, inner leg, and outer leg may thus be free of any bulges or the like in axial direction and the tube which is made of spiral-wound strip for interlocking in a manner which permits the resulting tube to flex or bend without compromising the gas-tight characteristics thereof and to have a cylindrical configuration in the area of these legs. The strip may be made of high-grade steel, e.g. grade 1.4301. As a result of the difference in the radial distances of inner leg and outer leg in relation to the tube axis, the transition necessarily has at least one radial component. Suitably, the transition, as a whole, extends radially, i.e. orthogonally to the tube axis. The loop hook may extend radially as a whole or also in part, i.e. with at least one direction component, and is normally placed on the one end of the inner leg or outer leg in opposition to the end that is connected to the transition. The end hook may extend radially as a whole or also in part and is typically connected to the outer leg, when the loop hook is connected with the inner leg. Suitably, the end hook is placed on the one end of the inner leg or outer leg in opposition to the end that is connected to the transition.

Typical configurations of the strip profile involve thus a sequence of the components “end leg-loop hook-inner leg-ransition-outer leg-end hook” or an alternate sequence in which the positions of the outer leg and inner leg are swapped.

The tube according to the invention can be substantially stretched depending on the dimensioning of the strip because neighboring turns, which are interlocked in the S-shaped region comprised of loop hook, inner leg, transition, outer leg, end hook, and end leg, are able to move unimpeded in the entire interlock interval. At the same time, the end leg adjoining the S-shaped region ensures sufficient stability of the tube and provides an additional overlap zone, even when the tube turns are stretched apart to a maximum.

According to another feature of the present invention, the end leg may be spaced from the tube axis by a radial distance which is smaller than a radial distance of the inner leg to the tube axis. As a result, the end leg is able to cover on the inside the inner leg of the neighboring strip winding. As an alternative, the end leg may be spaced from the tube axis by a radial distance which is greater than a radial distance of the outer leg to the tube axis. In this way, the end leg is able to cover on the outside the outer leg of the neighboring strip winding.

According to another feature of the present invention, the strip may be configured for an axial stretch of at least 47%. Currently preferred is an axial stretch of at least 60%. The term “stretch” is hereby defined by the percentage by which the tube at maximum length is longer than the tube at minimum length. In other words: Stretch=(Lₘₐₓ−Lₘᵢₙ)/Lₘᵢₙ, wherein Lₘᵢₙ is the tube length, when compressed to a minimum, and Lₘₐₓ is the tube length, when stretched to a maximum.

According to another feature of the present invention, the end hook may extend at an acute angle α in relation to the tube axis. Suitably, the angle α may range between about 30° and about 85°. Currently preferred is an angle α between about 60° and about 80°. By angling the end hook in this way, compared to a right-angled disposition, stability is enhanced and service life of the tube is extended. Suitably, the end hook points hereby in a direction of the profile and not away from it. In other words, the acute angle α is defined between the end hook and the adjacent inner or outer leg. As an alternative, these components may extend at an angle of 180°−α.

According to another feature of the present invention, the loop hook may extend at an acute angle β in relation to the tube axis. Suitably, the angle β may range between about 30° and about 85°. Currently preferred is an angle β between about 60° and about 80°. Suitably, the loop hook points away from the end leg, i.e. the acute angle β is defined between the loop hook and the adjacent inner or outer leg. The angle β may also be assumed to be defined between the loop hook and the end leg. The slanted disposition of the loop hook improves stability and service life of the tube. Together with the afore-described slanted disposition of the end hook, an interlock is realized which is designated as “semi-interfit” and ensures a greater tube stability, when the tube bends.

According to another feature of the present invention, the loop hook and the end hook are angled in relation to the tube axis at substantially same acute angles. When the tube is stretched to a maximum, end hook and loop hook lie coextensively upon one another.

According to another feature of the present invention, the inner leg may have an axial extent which is substantially the same as the axial extent of the outer leg. As a result, the inner legs and the outer legs of neighboring turns overlap as completely as possible, when the tube is compressed, to thereby allow a maximum tube compression. Suitably, the end leg has an axial extent which is at least 80% of an axial extent of the inner leg or the outer leg. The axial extent of the end leg may hereby be as long as the axial extent of the one of these both legs which is not connected to the end leg. This ensures still sufficient overlap of the end leg upon the inner leg or outer leg of a neighboring strip winding, when the tube is stretched to a maximum.

The radial extent of the end hook may be substantially the same as the radial extent of the loop hook. This optimizes a mutual engagement of the S-shaped regions. At least one of the end hook and loop hook may have a radial extent which is between 10 and 80% of an axial extent one of the inner leg and the outer leg. Currently preferred is a radial extent between 20 and 40% of the axial extent of the inner leg or the outer leg. These size ratios optimize stability, stretching capability, and movement.

According to another aspect of the present invention, a tube assembly includes a gastight external first tube, and a second tube disposed within the first tube and made of profiled metal strip which includes an end leg extending in parallel relationship to a tube axis, an inner leg extending in parallel relationship to the tube axis at a first distance, an outer leg extending in parallel relationship to the tube axis at a second distance which is greater than the first distance, a transition for connecting the inner leg with the outer leg, a double-folded loop hook extending radially for connecting the end leg with one member selected from the group consisting of the inner leg and the outer leg, and an end hook extending radially and connected to the other member of the group consisting of the inner leg and the outer leg.

A tube assembly according to the invention is in particular applicable as gas-tight decoupling element in exhaust systems of passenger cars or trucks for example. The external tube may hereby be configured as a metal bellows.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a cross section through four sequential turns of a first embodiment of a tube according to the present invention;

FIG. 2 is a cross section through four sequential turns of a second embodiment of a tube according to the present invention;

FIG. 3 is a schematic illustration of the tube of FIG. 1 disposed in a metal bellows;

FIG. 3A is an enlarged detailed view of the area encircled in FIG. 3 and marked “III”;

FIG. 4 is a schematic illustration of the tube of FIG. 2 disposed in a metal bellows;

FIG. 4A is an enlarged detailed view of the area encircled in FIG. 4 and marked “IV”; and

FIG. 5 is a schematic illustration of a strip profile for a tube according to the present invention, drawn to scale, with inner end legs and angled hook.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

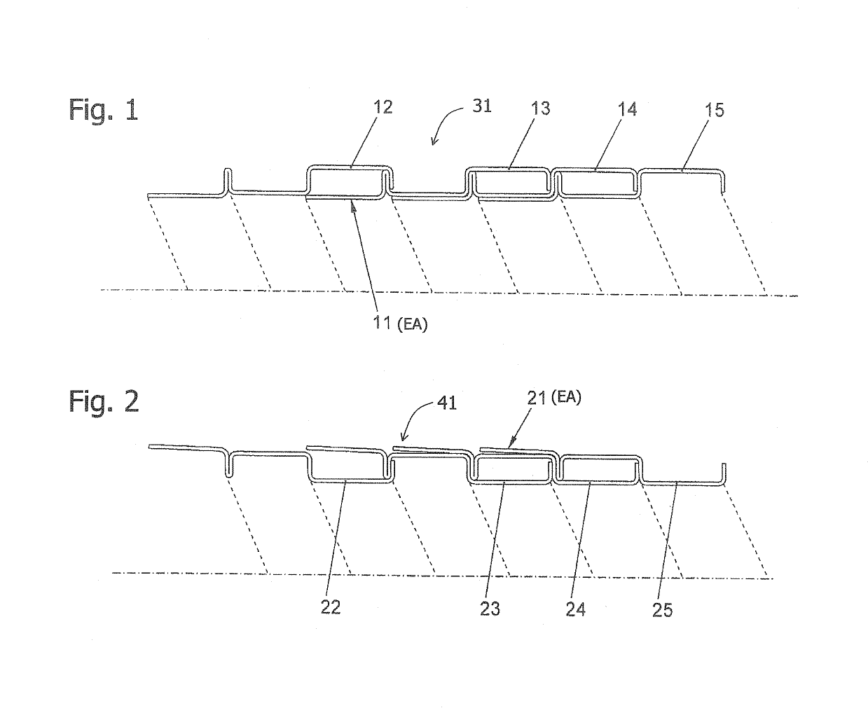

Turning now to the drawing, and in particular to FIG. 1, there is shown a cross section through four sequential turns or windings of a first embodiment of a tube according to the present invention, generally designated by reference numeral 31. The tube 31 is centered on a tube axis X and made of profiled metal strip which is spiral-wound for interlocking the turns. Tubes of this type are used as liner for conveying exhaust gases in decoupling elements of exhaust systems and can be received in gas-tight metal bellows to prevent turbulence in the exhaust flow and to enhance acoustic properties of the decoupling element.

The tube 31 has an S-shaped profile which is extended by an end leg 11. In the fragmentary view of FIG. 1, four neighboring turns are shown of the tube 31 which has end legs 11 that are positioned radially inwards. The tube 31 is hereby shown compressed in the right-hand drawing side and stretched in the left-hand drawing side.

The end leg 11 has an axial extent which is preferably about half the length of the S-shaped profile and is situated radially below the next tube turn, as shown in FIG. 1. The single S-shaped tube layers are hereby interlocked. The end leg 11 below the next tube layer provides mutual stability for the single tube layers and significantly reduces noise of the metal tube, caused by rattling. This reduction is partly realized by the stabilizing effect of the end leg 11. Moreover, the presence of the end leg 11 enhances the flow of exhaust gases and allows production of directionally stable and, at the same time, flexible tubes of very thin strip thicknesses.

A tube according to the invention further achieves greater stretch values so that shorter decoupling elements can be used. Stretch values of at least 47% up to 77% can be realized. As a result, the multilayer tube is especially useful for application as exhaust carrying element in small-sized decoupling elements. The geometry of the tube profile remains unaffected by thermal expansion which does not limit the mobility of the turns relative to one other so that tube flexibility is almost identical in cold or warm states.

FIG. 2 shows a cross section through four sequential turns of a second embodiment of a tube according to the present invention, generally designated by reference numeral 41 and differing from the tube 31 of FIG. 1 by the disposition of the end leg. In this embodiment, the end leg 21 is positioned radially outwards. The tube 41 is compressed in the right-hand drawing side and stretched in the left-hand drawing side.

The tubes 31, 41 shown in FIGS. 1 and 2, respectively, are made of a plurality of turns made in several layers by two spiral-wound profiled metal strips. The individual turns 12, 13, 14, 15 of the tube 31 of FIG. 1 and the individual turns 22, 23, 24, 25 of the tube 41 of FIG. 2 repeat in alternating fashion and are juxtaposed and interconnected over the length of the tube in a form-fitting manner.

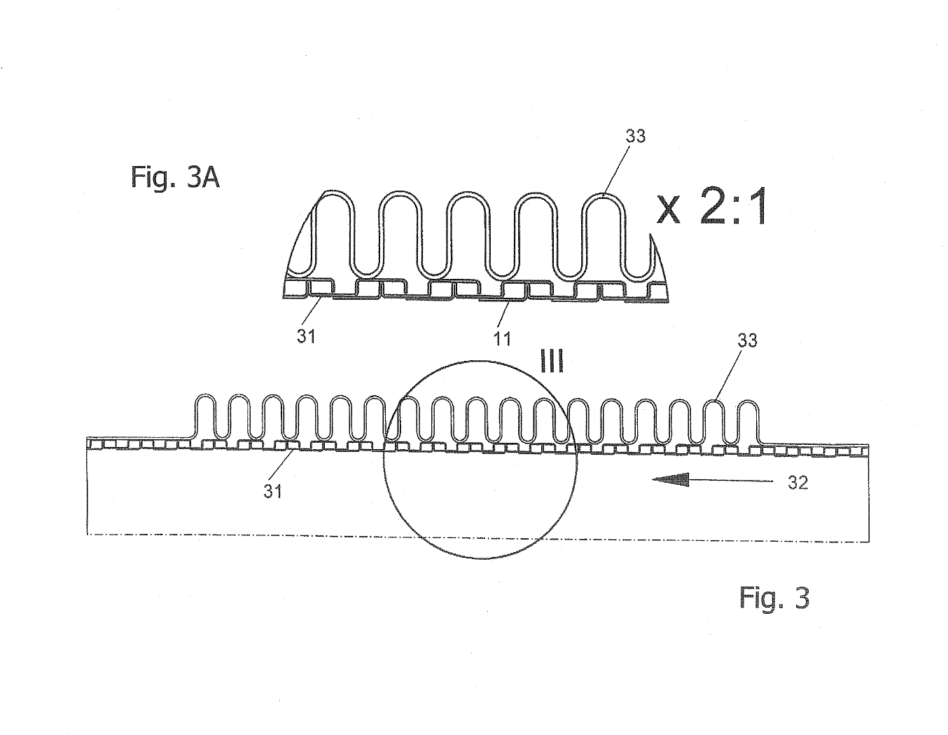

Turning now to FIG. 3, there is shown a schematic illustration of the tube 31 of FIG. 1, disposed in a corrugated conduit element or metal bellows 33, for conveying exhaust gas in a flow direction 32. The tube 31 is hereby used as liner in decoupling elements. Any number of peaks and valleys of the bellows 33 may be provided. The resultant decoupling element is flexible and gas-tight, without requiring a braiding about the tube, thereby reducing assembly and costs. FIG. 3A shows an enlarged detailed view of the area encircled in FIG. 3 and marked “III” at a scale of 2:1.

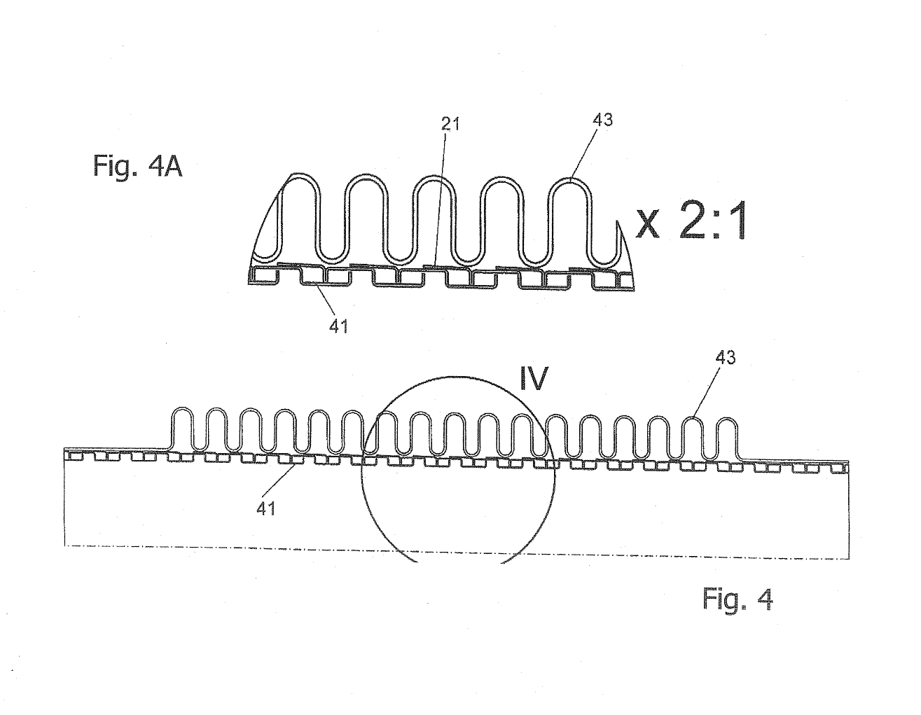

FIG. 4 shows a schematic illustration of the tube 41 of FIG. 2, disposed in a corrugated conduit element or metal bellows 43, to form a liner in decoupling elements for conveying exhaust gas in exhaust systems. FIG. 4A shows an enlarged detailed view of the area encircled in FIG. 4 and marked “IV” at a scale of 2:1. Also tube 41 does not require a surrounding braiding to provide the resultant decoupling element with superior flexibility and gas-tightness.

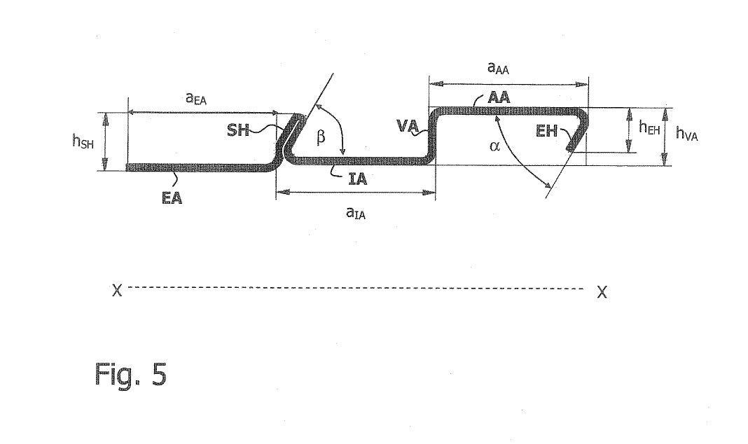

Referring now to FIG. 5, there is shown a schematic illustration of a strip profile for making a tube 31 according to the present invention, as described above. When the tube is wound, the tube axis X assumes the shown relative position. In other words, the profile bottom side in FIG. 5 corresponds to the tube inner side. The profile includes the following components:
an end leg EA which is disposed inwards in relation to the tube axis X and extends parallel to the tube axis X with an axial extent a_{EA};
a loop hook SH defined by a radial extent h_{SH} which extends at an acute angle β in relation to the tube axis;
an inner leg IA extending parallel to the tube axis X and defined by an axial length a_{IA};
a transition VA extending radially substantially perpendicular to the tube axis X;
an outer leg AA extending-parallel to the tube axis X and defined by an axial length a_{AA}, with the outer leg AA having a greater radial distance to the tube axis X than the inner leg IA
an end hook EH extending at an acute angle α in relation to the tube axis X and defined by a radial extent h_{EH}.

The afore-described components are interconnected at their ends in the stated sequence.

Although not shown or noticeable in FIGS. 1 to 4, the loop hook SH and the end hook extend at an acute angle, as this is shown in FIG. 5. An acute-angled disposition of the end hook EH significantly enhances stability and breaking strength of this component compared to a right-angled disposition. The acute angling of the loop hook SH corresponds to the slant of the end hook EH and prevents the tube to spring open, when stretched and bent.

The same considerations, as described in connection with the illustration of FIG. 5, are also applicable for making a tube 41 having end legs EA which are disposed radially outwards. This means only with respect to the illustration of FIG. 5 that the tube axis X is now arranged on the topside of the profile, whereby the designations of inner leg IA and outer leg AA are swapped as they relate to the radial distance from the tube axis X. In other words, depending on the winding direction, the same strip profile can be used for making a tube with inner end legs (FIGS. 1, 3, 5) or outer end legs (FIG. 2, 4).

A tube according to the invention can be made through suitable shaping process such that the individual turns lie above one another with an air gap or play therebetween, or with touch points, or in flat contact. Regardless of which variation, a tube according to the invention is flexible and mobile enough for application also as a very lightweight protective tube or as EMC (electromagnetic compatibility) shield.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A tube made of profiled metal strip, said strip comprising:
an end leg extending in parallel relationship to a tube axis;
an inner leg extending in parallel relationship to the tube axis at a first distance;
an outer leg extending in parallel relationship to the tube axis at a second distance which is greater than the first distance;
a transition for connecting the inner leg with the outer leg;
a double-folded loop hook extending radially for connecting the end leg with one member selected from the group consisting of the inner leg and the outer leg; and
an end hook extending radially and connected to the other member of the group consisting of the inner leg and the outer leg.

2. The tube of claim 1, wherein the strip is spiral-wound for interlocking adjacent turns of the strip.

3. The tube of claim 1, wherein the end leg is spaced from the tube axis by a radial distance which is smaller than a radial distance of the inner leg to the tube axis.

4. The tube of claim 1, wherein the end leg is spaced from the tube axis by a radial distance which is greater than a radial distance of the outer leg to the tube axis.

5. The tube of claim 1, wherein the strip is configured for an axial stretch of at least 47%.

6. The tube of claim 1, wherein the strip is configured for an axial stretch of at least 60%.

7. The tube of claim 1, wherein the end hook extends at an acute angle in relation to the tube axis.

8. The tube of claim 7, wherein the angle ranges between about 30° and about 85°.

9. The tube of claim 7, wherein the angle ranges between about 60° and about 80°.

10. The tube of claim 7, wherein the end hook is angled to point inwards toward the transition.

11. The tube of claim 1, wherein the loop hook extends at an acute angle in relation to the tube axis.

12. The tube of claim 11, wherein the angle ranges between about 30° and about 85°.

13. The tube of claim 11, wherein the angle ranges between about 60° and about 80°.

14. The tube of claim 7, wherein the loop hook extends in relation to the tube axis at an acute angle which is substantially the same as the acute angle between the end hook and the tube axis.

15. The tube of claim 11, wherein the loop hook is angled to point away from the end leg.

16. The tube of claim 1, wherein the inner leg has an axial extent which is substantially the same as the axial extent of the outer leg.

17. The tube of claim 1, wherein the end leg has an axial extent which is at least 80% of an axial extent of one of the inner leg and the outer leg.

18. The tube of claim 1, wherein at least one of the end hook and loop hook has a radial extent which is between 10 and 80% of an axial extent of one of the inner leg and the outer leg.

19. The tube of claim 1, wherein the radial extent is between 20 and 40%.

20. A tube assembly, comprising:
a gastight external first tube; and
a second tube disposed within the first tube and made of profiled metal strip, said strip comprising:
an end leg extending in parallel relationship to a tube axis;
an inner leg extending in parallel relationship to the tube axis at a first distance;
an outer leg extending in parallel relationship to the tube axis at a second distance which is greater than the first distance;
a transition for connecting the inner leg with the outer leg;
a double-folded loop hook extending radially for connecting the end leg with one member selected from the group consisting of the inner leg and the outer leg; and
an end hook extending radially and connected to the other member of the group consisting of the inner leg and the outer leg.

21. The tube assembly of claim 20, wherein the first tube is a metal bellows.
